(19) United States
(12) Patent Application Publication
(10) Pub. No.: US 2013/0236721 A1
(43) Pub. Date: Sep. 12, 2013

(54) CARBON NANOTUBES FOR TRANSFER BELT APPLICATIONS

(71) Applicant: XEROX CORPORATION, Norwalk, CT (US)

(72) Inventor: Kock-Yee Law, Penfield, NY (US)

(73) Assignee: Xerox Corporation, Norwalk, CT (US)

(21) Appl. No.: 13/874,870

(22) Filed: May 1, 2013

Related U.S. Application Data
(62) Division of application No. 11/614,408, filed on Dec. 21, 2006, now abandoned.

(51) Int. Cl. G03G 15/16

(52) U.S. Cl. CPC G03G 15/162
USPC 428/339; 428/421; 428/422

(57) ABSTRACT

A xerographic transfer member includes a resistive, electrically relaxable, polyimide substrate, and a conformance resistive layer that includes a fluoroelastomer composite. The fluoroelastomer composite includes a cross-linked fluoropolymer, a plurality of carbon nanotubes, and exhibits a resistivity from about 10⁷ ohm-cm to about 10¹³ ohm-cm.

### CROSS-REFERENCE TO RELATED APPLICATIONS

This application claims priority to, and is a divisional application of, U.S. patent application Ser. No. 11/614,408, filed Dec. 21, 2006, the disclosure of which is incorporated by reference herein in its entirety.

### BACKGROUND

1. Technical Field

This disclosure relates to electrically conductive coatings and processes for their preparation. The disclosure relates to processes for producing electrically conductive coatings useful for components for electrical applications, especially electrostatographic applications such as xerographic applications. Specifically, this disclosure relates to intermediate transfer components that are useful in transferring a developed image in an electrostatographic, especially xerographic machine or apparatus.

2. Description of the Related Art

In a typical electrostatographic reproducing apparatus, a light image of an original to be copied is recorded in the form of an electrostatic latent image upon a photosensitive member and the latent image is subsequently rendered visible by the application of electroscopic thermoplastic resin particles which are commonly referred to as toner. Generally, the electrostatic latent image is developed by bringing a developer mixture into contact with the latent image. A dry developer mixture usually comprises carrier granules that have toner particles adhering triboelectrically to the carrier granules. Toner particles are attracted from the carrier granules to the latent image forming a toner image.

Alternatively, a liquid developer material may be employed. The liquid developer material includes a liquid carrier with dispersed toner particles. The liquid developer material is contacted with the electrostatic latent image and the toner particles are deposited in the latent image configuration. After the toner particles have been deposited on the photoconductive surface, in image configuration, the image is transferred to a copy sheet. However, when a liquid developer material is employed, the copy sheet is wet with both the toner particles and the liquid carrier. Thus, it is necessary to remove the liquid carrier from the copy sheet. This may be accomplished by drying the copy sheet prior to fusing of the toner image, or relying upon the fusing process to permanently fuse the toner particles to the copy sheet as well as vaporizing the liquid carrier. It is desirable to refrain from transferring any liquid carrier to the copy sheet. Therefore, it is advantageous to transfer the developed image to a coated intermediate transfer web, belt or component, and subsequently transfer with very high transfer efficiency the developed image from the intermediate transfer component to a permanent substrate. The toner image is usually fixed or fused upon a support which may be the photosensitive member itself or other support sheet such as plain paper.

In electrostatographic printing machines, the toner image is electrostatically transferred by a potential between the imaging member and the intermediate transfer member. The transfer of the toner particles to the intermediate transfer member and their retention on the intermediate transfer member should be as complete as possible so that the image ultimately transferred to the image receiving substrate will have a high resolution. Substantially 100% toner transfer occurs when most or all of the toner particles comprising the image are transferred and little residual toner remains on the surface from which the image was transferred. Substantially 100% toner transfer is especially important for generating full color images since undesirable shifting or color deterioration in the final colors can occur when the primary color images are not accurately and efficiently transferred to and from the intermediate transfer members.

Although intermediate transfer members allow for positive attributes such as enabling high throughput at modest process speeds, improving registration of the final color toner image in color systems using synchronous development of one or more component colors using one or more transfer stations, and increasing the range of final substrates that can be used, a disadvantage of using an intermediate transfer member is that a plurality of transfer steps is required allowing for the possibility of charge exchange occurring between toner particles and the transfer member which ultimately leads to less than complete toner transfer. The result is low resolution images on the image receiving substrate and image deterioration. When the image is in color, the image additionally suffers from color shifting and color deterioration. In addition, the use of charging agents in liquid developers, although providing good quality images and acceptable resolution due to improved charging of the toner, can exacerbate the problem of charge exchange between the toner and the intermediate transfer member.

To help decrease charge exchange and increase toner transfer, the resistivity of the intermediate transfer member should be within a desired range, and preferably, wherein the resistivity is virtually unaffected by changes in humidity, temperature, bias field, and operating time. Attempts at controlling the resistivity of intermediate transfer members have been accomplished, for example, by adding conductive fillers such as ionic additives and/or carbon black to the conformable layer.

U.S. Pat. No. 6,141,516, which is incorporated by reference in its entirety herein, discloses an outer layer on a bias charging member that includes an aqueous latex coating that includes fluorinated carbon in a fluoroelastomer. The resistivity of the coating can be chosen and controlled depending upon the amount of fluorinated carbon, the kind of curative, the amount of curative, the amount of fluorine in the fluorinated carbon, and the curing procedures including the specific curing agent, curing time and curing temperature.

U.S. Pat. No. 6,103,815, which is incorporated by reference in its entirety herein, discloses a latex fluorocarbon elastomer and fluorinated carbon composition that is useful for xerographic component surfaces.

U.S. Pat. No. 5,849,399, which is incorporated by reference in its entirety herein, discloses a biasable transfer member that includes an electrically conductive core, and an outer layer that includes a fluorinated carbon filled fluoroelastomer.

U.S. Pat. No. 5,795,500, which is incorporated by reference in its entirety herein, discloses a composition of fluorinated carbon in a fluoroelastomer. The resistivity of the coating can be chosen and controlled depending upon the amount of fluorinated carbon, the kind of curative, the amount of curative, the amount of fluorine in the fluorinated carbon, and the curing procedures including the specific curing agent, curing time and curing temperature.

U.S. Pat. No. 5,761,595, which is incorporated by reference in its entirety herein, discloses a resistive transfer component having at least one fluorinated carbon filled fluoroelastomer layer.

U.S. Pat. No. 5,567,565, which is incorporated by reference in its entirety herein, discloses a fluorocarbon elastomer intermediate transfer member for use with liquid developers and which achieves substantially 100% toner transfer.

U.S. Pat. No. 5,525,446, which is incorporated by reference in its entirety herein, discloses an intermediate transfer member for use with color systems which includes a base layer and a top polycarbonate layer, wherein the top layer can include electrical property regulating materials such as metal oxides or carbon black.

U.S. Pat. No. 5,456,987, which is incorporated by reference in its entirety herein, discloses an intermediate transfer component for both dry and liquid toner, comprising a substrate and a coating comprised of integral, interpenetrating networks of haloelastomer, titanium oxide and optionally polyorganosiloxane, wherein the substrate may include dielectric or conductive fillers such as carbon or metal oxide particles.

U.S. Pat. No. 5,340,679, which is incorporated by reference in its entirety herein, discloses an intermediate transfer component for both dry and liquid toner, wherein the intermediate transfer component comprises a substrate and a coating comprised of a volume grafted elastomer. The substrate may include dielectric or conductive fillers such as carbon or metal oxide particles.

U.S. Pat. No. 5,337,129, which is incorporated by reference in its entirety herein, discloses an intermediate transfer component useful in dry and/or liquid toner systems, wherein the intermediate transfer component comprises a substrate and a coating comprised of integral, interpenetrating networks of haloelastomer, silicon oxide and optionally polyorganosiloxane, wherein the substrate may include dielectric or conductive fillers such as carbon or metal oxide particles.

While addition of electrically conductive additives to polymers may partially control the resistivity of polymer coatings or layers to some extent, there are problems associated with the use of these additives, such as problems with non-uniform dispersion. In particular, particles frequently bloom or migrate to the surface of the polymer and cause an imperfection in the polymer. This leads to a non-uniform resistivity, which in turn, leads to poor antistatic properties and poor mechanical strength.

Carbon black particles can impart other specific adverse effects. Such carbon dispersions are difficult to prepare due to carbon gelling, and the resulting layers may deform due to gelatin formation. This can lead to an adverse change in the conformability of the layer, which in turn, can lead to insufficient transfer and poor copy quality, and possible contamination of other machine parts and later copies.

Generally, carbon additives control resistivity of coatings and provide somewhat stable resistivity upon changes in temperature, relative humidity, running time, and leaching out of contamination to photoconductors. However, the required tolerance in the filler loading to achieve the required range of resistivity is narrow. This, along with the large “batch to batch” variation, leads to the need for extremely tight resistivity control. In addition, carbon filled polymer surfaces have typically had very poor dielectric strength and sometimes significant resistivity dependence on applied fields. This leads to a compromise in the choice of centerline resistivity due to the variability in the electrical properties, which in turn, ultimately leads to a compromise in performance.

Therefore, there exists an overall need for compositions useful as coatings or layers for xerographic components and processes for producing such coatings or layers, which provide for increased toner transfer efficiency and a decrease in the occurrence of charge exchange or toner offset. More specifically, there exists a specific need for a composition useful as coatings or layers for xerographic components that has controlled resistivity in a desired range so as to neutralize toner charges, thereby decreasing the occurrence of charge exchange or toner offset, increasing image quality, and preventing contamination of other xerographic members. In addition, there exists a specific need for an intermediate transfer member which has an outer surface having the qualities of a stable resistivity in the desired resistivity range and in which the conformability and low surface energy properties of the release layer are not affected.

The disclosure contained herein describes attempts to address one or more of the problems described above.

### SUMMARY

In an embodiment an intermediate transfer member may include a substrate and a conformance resistive layer on the substrate. The conformance resistance layer may include a fluoroelastomer and a plurality of carbon nanotubes.

In yet another embodiment, an intermediate transfer member substrate may include a polyimide.

In still another embodiment, the conformance resistive layer may include a reaction product of a fluoropolymer and a curing agent. In embodiments, the fluoropolymer may have a monomeric repeat unit that may be selected from the group consisting of vinylidene fluoride, hexafluoropropylene, tetrafluoroethylene, and mixtures thereof.

A curing agent of embodiments may include at least two cross-linking functional groups selected from the group consisting of phenol, amine, olefin, and mixtures thereof.

In still yet another embodiment, the carbon nanotubes may be selected from the group consisting of single-walled carbon nanotubes, multi-walled carbon nanotubes, carbon nanofibers, and mixtures thereof. In some embodiments a carbon nanotube concentration in the conformance resistive layer may be about 0.001% to about 2% by weight.

Embodiments of an intermediate transfer member may include a conformance resistive layer having an electrical resistivity in a range of about 10⁷ ohm-cm to about 10¹³ ohm-cm. The thickness of a conformance resistive layer may be about 1 mil to about 6 mil.

The transfer member of embodiments may include a toner release layer over the fluoroelastomer composite coating. In certain embodiment, the toner release layer may be a silicone.

In another embodiment, a method includes dispersing a plurality of carbon nanotubes and a fluoropolymer into an effective solvent to form a suspension, and coating the suspension onto a transfer member substrate to form a conformance resistive layer on the transfer member substrate.

A further embodiment may include adding a cross-linking agent to the suspension prior to coating. In another embodiment the conformance resistive layer may be cured. In some embodiments, a basic oxide may be added to the suspension prior to adding the cross-linking agent.

In still another embodiment, the carbon nanotubes and fluoropolymer may be blended together prior to dispersing into the effective solvent.

The carbon nanotubes of embodiments herein may be selected from the group consisting of single-walled carbon nanotubes, multi-walled carbon nanotubes, carbon nanofibers, and mixtures thereof, and the carbon nanotube concentration in the conformance resistive layer may be about 0.001% to about 2% by weight.

The fluoropolymer of embodiments may have monomeric repeat units that are selected from the group consisting of vinylidene fluoride, hexafluoropropylene, tetrafluoroethylene, and mixtures thereof.

An effective solvent of embodiments may be selected from the group consisting of methyl isobutyl ketone, methyl ethyl ketone, and mixtures thereof.

Other embodiments may include adding a surfactant to the suspension.

In embodiments, the coating method may be selected from the group consisting of gap, flow, draw down, spin casting, dip, spin, spray, and extrusion coating.

A further embodiment includes an imaging system. An imaging system may include a transfer member. A transfer member of embodiments of an imaging system may include a resistive, electrically relaxable, polyimide substrate, and a conformance resistive layer on the substrate. A conformance resistive layer of embodiments may include a fluoroelastomer composite. A fluoroelastomer composite of embodiments may include a cross-linked fluoropolymer, a plurality of carbon nanotubes, and may exhibit a resistivity from about 10⁷ ohm-cm to about 10¹³ ohm-cm.

### BRIEF DESCRIPTION OF THE DRAWINGS

FIG. 1 depicts a xerographic imaging system.

FIG. 2 depicts a multi-layer intermediate transfer member having two layers.

FIG. 3 depicts a multilayer intermediate transfer member having three layers.

FIG. 4 is a flow diagram of exemplary method to manufacture a multi-layer intermediate transfer member.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

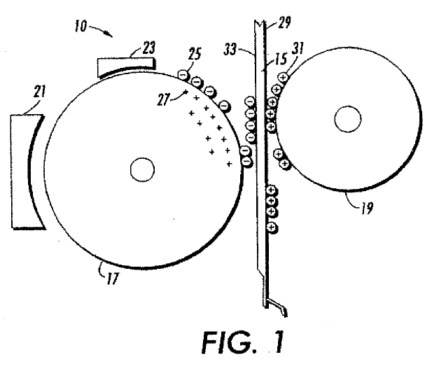

Referring to FIG. 1, an embodiment herein includes an image development system 10 having an intermediate transfer member 15. The intermediate transfer member 15 may be positioned between and imaging member 17 and a biased transfer roller 19. In FIG. 1 the imaging member 17 is exemplified by a photoreceptor drum. In other embodiments, the imaging member may include other electrographic imaging receptors such as ionographic belts and drums, electrographic belts, and any other electrographic imaging receptor known now or hereinafter to one of ordinary skill in the art.

In an embodiment of an imaging system 10, a latent image is formed on the imaging member 17 by an image forming station 21 and developed at a developing station 23. The image is then transferred to an intermediate transfer member 15. For a multi-imaging system, each of the images may be formed on the imaging member 17, developed sequentially and then transferred to the intermediate transfer member 15. In an embodiment, the imaging system 10 may be a color or black and white copying system. In yet another embodiment, the imaging system 10 may include a color or black and white printing system.

When the image is developed at the developing station 23, charged toner particles 25 from the developing station 23 are attracted and held by the imaging member 17 because the imaging member possesses a charge 27 opposite to that of the toner particles 25. While in FIG. 1 the toner particles 25 are depicted with a negative charge and the imaging member 17 with a positive charge, the charges can be reversed depending upon the characteristics of the toner and the machinery. Embodiments herein may include a liquid or a dry toner.

A biased transfer roller 19 positioned opposite the imaging member 17 has a higher voltage than the surface of the imaging member 17. As depicted in FIG. 1, a biased transfer roller 19 may charge the back side 29 of an intermediate transfer member 15 with a positive charge 31. Alternatively, the back side 29 of an intermediate transfer member 15 may be charged by a corona or any other charging method known to those of skill in the art.

Negatively charged toner particles 25 are attracted to the front side 33 of the positively charged 31 intermediate transfer member 15. The intermediate transfer member 15 may be in the form of a sheet, a web, a belt, or any other form suitable shape for transferring the toner particles 25.

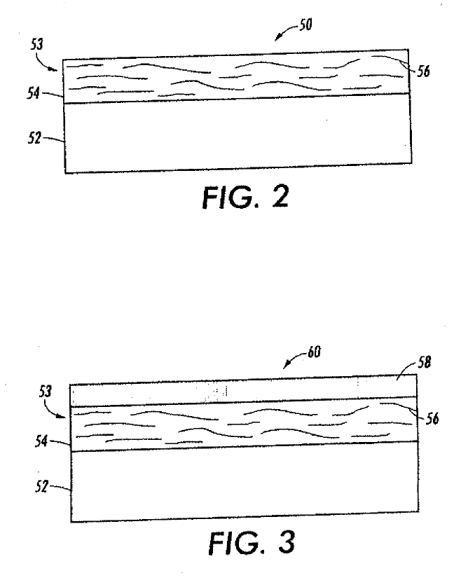

In embodiments, as depicted in FIGS. 2 and 3, an intermediate transfer member 50, 60 may be a multilayered structure. FIG. 2 is an embodiment of a two-layer intermediate transfer member 50 and FIG. 3 is an embodiment of a three-layer intermediate transfer member 60. It is desirable for an intermediate transfer member 50, 60 to be dimensionally stable and resistant to materials of the toner or developer. In an embodiment, electrically relaxable, resistive polyimide may be used as a substrate 52 for an intermediate transfer member 50, 60.

It is also desirable for an intermediate transfer member 50, 60 to be conformable to image receiving substrates. Conformance or conformability means that the material is able to contact an image receiving substrate with substantially complete smoothness. The material conforms to match the topography or contour of the substrate. Fluoroelastomers have been used for a conformance resistive layer because of the high Young's modulus, thermal stability, and conformance.

The intermediate transfer member needs to be conductive enough to enable the creation of an electrical field upon electrical biasing, and resistive enough so that electrical leakage will not occur while biasing. The intermediate transfer member needs to be electrically relaxed so that charges will not be accumulated after each xerographic cycle. Therefore, knowledge of the dielectric relaxation time of the intermediate transfer member is important. The most accessible measurable parameter for the relaxation time is the electrical resistivity or the resistance, both surface and bulk, of the materials or the surface coating of the intermediate transfer member.

The precise resistivity may be dependent on the print engine design, process speed, component geometry, and latitude. A desirable range of resistivity for xerographic applications including an intermediate transfer member is in the range from about 10⁷ to about 10¹³ ohm-cm. Materials with resistivities within the desirable range are neither electrically insulating (>10¹³ ohm-cm) not electrically conducting (<10⁵ ohm cm). A cost-effective approach to achieve this resistivity has been to add conductive filler to the fluoroelastomer. Heavy loading with fillers (calculated to be about 16% (v/v) for spherical particles) may be required to achieve the desired resistivity. While achieving the desired electrical properties, the use of fillers often reduces conformance.

Referring now back to FIGS. 2 and 3, it is determined that an embodiment of a conformance resistive layer 53 of an intermediate transfer member or transfer belt 50, 60 may include a fluoroelastomer 54 loaded with carbon nanotubes 56 (CNTs). In an embodiment, the conformance resistive coating layer 53 may include a reaction product of a fluoropolymer and a curing agent to form a cross-linked fluoroelastomer 54. In a further embodiment of a conformance resistive layer 53 of an intermediate transfer member 50, 60, the fluoropolymer may have a monomeric repeat unit that is selected from the group consisting of vinylidene fluoride, hexafluoropropylene, tetrafluoroethylene, and mixtures thereof. In still other embodiments of the intermediate transfer member 50, 60, the curing agent may include at least two cross-linking functional groups selected from the group consisting of phenol, amine, olefin, and mixtures thereof.

The desired resistivity of the conformance resistive layer 53, that is between about 10⁷ and about 10¹³ ohm-cm, is achieved with a CNT 56 loading of less than about 2% (w/w). In other embodiments, the CNT fillers 56 are dispersed in the fluoroelastomer from about 0.001% to about 2% (w/w) of the conformance resistive layer 53. In other embodiments the CNT concentration in the fluoroelastomer may be from about 0.001% to about 5% (w/w). In yet other embodiments, the CNT concentration in the fluoroelastomer may be from about 0.01% to about 1% (w/w). The CNTs may be effective in providing the desired resistivity at low loading levels due to their high aspect ratio. While CNTs measure a few nanometers in diameter, they can be several millimeters in length. Therefore only a relatively low loading is required to make a continuous electrical path through the fluoroelastomer to bring the resistivity of the conformance resistive layer 53 into the desired “semiconductor” range of about 10⁷ ohm-cm to about 10¹³ ohm-cm. Due to the low loading of CNTs, the mechanical and conformance properties are not significantly changed or compromised.

CNTs dispersed in the fluoropolymer or fluoroelastomer is an example of a solid-solid dispersion. A dispersion is a two-phase system where one phase consists of finely divided particles, often in the colloidal size range, distributed throughout a bulk substance, the particles being the dispersed or internal phase, and the bulk substance the continuous phase. (Hawley's Condensed Chemical Dictionary, 14^{th} Ed, Rev. by R. J. Lewis, Sr., John Wiley & Sons, Inc., New York (2001) p. 415).

Carbon nanotubes (CNTs) are an allotrope of carbon. They take the form of cylindrical carbon molecules and have novel properties that make them useful in a wide variety of applications in nanotechnology, electronics, optics and other fields of materials science. They exhibit extraordinary strength and unique electrical properties, and are efficient conductors of heat. Carbon nanofibers are similar to carbon nanotubes in dimension and they are cylindric structures, but they are not perfect cylinders, as are CNTs. Carbon nanofibers are within the scope of embodiments herein.

Nanotubes are members of the fullerene structural family, which also includes buckyballs. Whereas buckyballs are spherical in shape, a nanotube is cylindrical. The diameter of a nanotube is on the order of a few nanometers, while they can be up to several millimeters in length. There are two main types of nanotubes: single-walled nanotubes (SWNTs) and multi-walled nanotubes (MWNTs), both of which are encompassed in embodiments herein.

Referring now to FIG. 3, an embodiment of an intermediate transfer member 60 may include a toner release layer 58 over the conformance resistive layer 53. The toner release layer may include a silicone, siloxane, or polysiloxane. In an embodiment, a toner release layer 58 may include dimethylsiloxane.

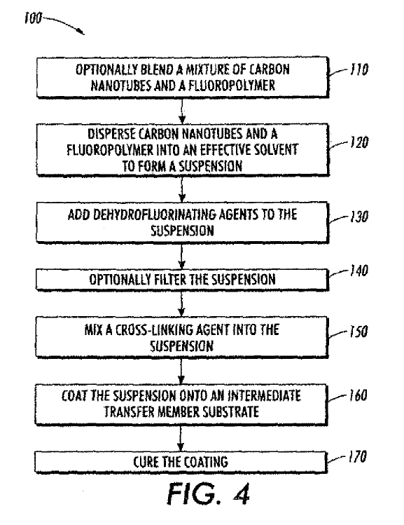

Referring to FIG. 4, an exemplary method of preparing an intermediate transfer belt 100 is presented. The method 100 includes extruding, or otherwise blending 110, a mixture of carbon nanotubes (CNTs) and a fluoropolymer to form a composite, wherein the composite has a loading of CNTs of about 0.001% to about 2% (w/w). In other embodiments the CNT concentration in the fluoroelastomer may be from about 0.001% to about 5% (w/w). In yet other embodiments, the CNT concentration in the fluoroelastomer may be from about 0.01% to about 1% (w/w). In an embodiment, the blending may be accomplished with a twin screw extruder. An exemplary process may involve the use of a commercially prepared masterbatch of CNT/fluoropolymer material, followed by lowering the concentration of CNT by a letdown extrusion process, where the masterbatch is co-extruded with a neat fluoropolymer. For example, a commercially prepared masterbatch of 12% (w/w) multi-walled CNT in a fluoropolymer Viton®-A (E. I. du Pont de Nemours and Company) is available from Hyperion Catalysis International. For embodiments herein, it may be desirable to lower the CNT concentration in the final composite extrudate to a range of about 0.001% to about 2%. As such, a masterbatch as described, for example, may be co-extruded with a neat fluoropolymer, such as Viton®-GF. The resulting letdown polymer may have a final concentration of CNTs of about 0.001% to about 2% (w/w). Alternatively, the desired concentration of CNTs could be added to neat fluoropolymer and blended.

Referring back to FIG. 4, once the desired concentration of CNTs is blended into a composite, the composite itself is dispersed 120 into an effective solvent to form a suspension. Alternatively, a desired amount of fluoropolymer and CNTs may be added to an effective solvent without initially blending the CNTs and fluoropolymer. Effective solvents include, but are not limited to, methyl isobutyl ketone (MIBK), methyl ethyl ketone (MEK), and mixtures thereof.

The suspensions may be sonicated to aid in dispersing the suspension. The methods of sonication, that is, using an ultrasonic bath or ultrasonic probe for agitation of solutions and suspensions is known to those of skill in the art and need not be further elaborated upon here. Optionally surfactants may be added to the suspensions. The use of surfactants is well known to those skilled in the art.

A suspension is a system in which very small particles (solid, semisolid, or liquid) are more or less uniformly dispersed in a liquid or gaseous medium. If the particles are small enough to pass through filter membranes the system is a colloidal suspension. The term colloids refer to matter when one or more of its dimensions lie in the range between 1 millimicron (nanometer) and 1 micron (micrometer). (Hawley's Condensed Chemical Dictionary, 14^{th} Ed, Rev. by R. J. Lewis, Sr., John Wiley & Sons, Inc., New York (2001) pp. 286, 1062).

In embodiments herein, when the CNT and fluoropolymer materials are dispersed into an effective solvent, a suspension is formed. Embodiments of the suspension herein could be considered a colloidal suspension, since they are able to pass through filter membranes. In addition, a solid in liquid colloidal suspension can interchangeably be referred to as a colloidal dispersion (or loosely called a solution). (Hawley's Condensed Chemical Dictionary, 14^{th} Ed, Rev. by R. J. Lewis, Sr., John Wiley & Sons, Inc., New York (2001) pp. 415, 1062).

Continuing to refer to FIG. 4, optionally, surfactants may be added to a second solvent, and this solvent mixture may include basic oxides, such as MgO and Ca(OH)₂ that act as dehydrofluorinating agents or acid acceptors, which aid in cross-linking the fluoropolymer 130. The optional second solvent mixture may also be sonicated.

The suspension may be filtered 140 through, for example, a filter disc with a 20 μm pore-size. Filtering 140 is utilized to remove non-colloidal solids, such as the basic oxide particles, so they are not present in the substrate coating.

A solution of bonding agent, curing agent, or cross-linker may be mixed into to the filtered suspension 150. Exemplary cross-linkers are bisphenol compounds. An exemplary bisphenol cross-linker may comprise Viton® Curative No. 50 (VC-50) available from E. I. du Pont de Nemours, Inc. VC-50 is soluble in a solvent suspension of the CNT and fluoropolymer and is readily available at the reactive sites for cross-linking Curative VC-50 contains Bisphenol-AF as a cross-linker and diphenylbenzylphosphonium chloride as an accelerator. Bisphenol-AF is also known as 4,4′-(hexafluoroisopropylidene)diphenol. The suspension containing the cross-linker is mixed briefly, as the cross-linking in solution occurs rapidly.

The suspension with the cross-linkers is coated 160 onto a suitable substrate for an intermediate transfer member. Suitable substrates for intermediate transfer members may include belts, drums, webs, and the like. In an embodiment the suitable substrate may include an electrically relaxable, resistive polyimide.

Gap coating can be used to coat a flat substrate, such as a belt or plate, whereas flow coating can be used to coat a cylindrical substrate, such as a drum or roll. Various means of coating the substrates, such as but not limited to gap, flow, draw down, spin casting, dip, spin, spray, and extrusion coating are familiar to those skilled in the art and need not be elaborated upon herein. Any method of coating known now or hereafter to those skilled in art is within the scope of embodiments herein. The coating processes are used to form a conformance resistive layer with a coating thicknesses of about 1 mil to about 6 mil. In other embodiments, a conformance resistive layer has a thickness of about 2 mil to about 4 mil.

After coating, the solvent may be at least partially evaporated (not shown in FIG. 4). In an exemplary embodiment, the solvent is allowed to evaporate for about two hours or more at room temperature. Other evaporation times and temperatures are within the scope of embodiments herein.

Following evaporation the conformance resistive layer coating may be cured 170 to form a fluoroelastomer/CNT composite conformance resistive layer. An exemplary curing process is a step-wise cure. For example, the coated substrate may be placed in a convection oven at about 149° C. for about 2 hours; the temperature may be increased to about 177° C. and further curing may take place for about 2 hours; the temperature may be increased to about 204° C. and the coating is further cured at that temperature for about 2 hours; lastly, the oven temperature may be increased to about 232° C. and the coating may be cured for another 6 hours. Other curing schedules are possible. Curing schedules known now or hereinafter to those skilled in the art are within the scope of embodiments herein.

Embodiments of fluoropolymers herein include the Viton® fluoropolymers from E. I. du Pont de Nemours, Inc. Viton® fluoropolymers include for example: Viton®-A, copolymers of hexafluoropropylene (HFP) and vinylidene fluoride (VDF or VF2), Viton®-B, terpolymers of tetrafluoroethylene (TFE), vinylidene fluoride (VDF) and hexafluoropropylene (HFP); and Viton®-GF, tetrapolymers composed of TFE, VF2, HFP, and small amounts of a cure site monomer. In an embodiment, the conformance resistive layer of an intermediate transfer belt may include a monomeric repeat unit that is selected from the group consisting of vinylidene fluoride, hexafluoropropylene, tetrafluoroethylene, and mixtures thereof. The fluoropolymers may comprise linear or branched polymers, and cross-linked fluoroelastomers, and may be cross-linked with bisphenol compounds, such as but not limited to, 4,4′-(hexafluoroisopropylidene) diphenol. The fluoropolymers may also comprise brominated peroxide cure sites, or other cure sites known to those skilled in the art, that can be use for free radical curing of the fluoropolymers.

Effective solvents of embodiments herein include, but are not limited to, methyl isobutyl ketone and methyl ethyl ketone. Other solvents that form stable suspensions, as described herein, are within the scope of the embodiments herein and include those solvents known now or hereafter by one of ordinary skill in the art.

Another embodiment includes an imaging system. The imaging system may include a transfer member. The transfer member may include a resistive, electrically relaxable, polyimide substrate, and a conformance resistive layer. The conformance resistive layer may include a fluoroelastomer composite. A fluoroelastomer composite may include a cross-linked fluoropolymer, a plurality of carbon nanotubes, and exhibits a resistivity from about 10⁷ ohm-cm to about 10¹³ ohm-cm.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A transfer member, comprising:
a substrate and a conformance resistive layer on the substrate, the conformance resistive layer comprising a reaction product of a fluoropolymer and a curing agent, and a plurality of carbon nanotubes;
wherein:
the substrate comprises a polyimide;
a carbon nanotube concentration in the conformance resistive layer is 0.01% to 1% by weight;
the conformance resistive layer comprises an electrical resistivity in a range of 10⁷ ohm-cm to 10¹³ ohm-cm;
the fluoropolymer comprises a monomeric repeat unit that is selected from the group consisting of vinylidene fluoride, hexafluoropropylene, tetrafluoroethylene, and mixtures thereof; and
the curing agent comprises at least two cross-linking functional groups selected from the group consisting of phenol, amine, olefin, and mixtures thereof.

2. The transfer member of claim 1, wherein:
the conformance resistive layer comprises a thickness of 1 mil to 6 mil.

3. The transfer member of claim 1 further comprising a toner release layer over the conformance resistive layer; wherein the toner release layer comprises a silicone.
